(19) United States
(12) Patent Application Publication
(10) Pub. No.: US 2018/0346773 A1
(43) Pub. Date: Dec. 6, 2018

(54) ADHESIVE FORMULATION

(71) Applicant: Dow Global Technologies LLC, Midland, MI (US)

(72) Inventors: Timothy S. De Vries, Midland, MI (US); Gary L. Jialanella, Oxford, MI (US); Bindu Krishnan, Lake Jackson, TX (US); Richard J. Keaton, Pearland, TX (US)

(21) Appl. No.: 15/761,610

(22) PCT Filed: Sep. 29, 2016
(86) PCT No.: PCT/US2016/054300

§ 371 Date: Mar. 20, 2018

Related U.S. Application Data
(60) Provisional application No. 62/237,092, filed on Oct. 5, 2015.

(51) Int. Cl. C09J 171/02; C09J 5/06; C09J 11/06

(52) U.S. Cl. CPC C09J 171/02; C08K 5/57; C09J 11/06; C09J 5/06

(57) ABSTRACT

An adhesive formulation including: (a) at least one polyol having an average functionality number of greater than 3 and a hydroxyl equivalent weight of from about 300 g/mol OH to about 3,000 g/mol OH; and (b) at least one tin catalyst compound; wherein the adhesive formulation exhibits a latency of greater than 10 minutes open time; and a process for preparing the adhesive formulation.

### FIELD

The present invention is related to an adhesive formulation; and more specifically, to a two-part adhesive formulation useful in the automotive industry.

### BACKGROUND

Carbon footprint has become an important issue, impacting passenger vehicles as it relates to the carbon dioxide emissions and legislation relating to these emissions. Lightweighting associated with new materials has become a crucial part of the strategy for achieving fuel economy targets in the designs of new vehicle models. The introduction of aluminum, magnesium, sheet molding compounds (SMC), and carbon fiber composites for use in replacement of steel components in the automotive industry is being implemented quickly on new automobile models; and adhesive formulations are enabling this approach since the new and dissimilar materials are difficult or even impossible to weld. While adhesive formulations are being used in the automotive industry, there still remains a need for improvement in latency of the adhesive formulation systems known in the prior art to increase open time for working with the adhesive while maintaining a snap-cure profile on thermal activation.

Typically, a polyol formulation is used to test, demonstrate and prove the functionality of a new catalyst in the polyol formulation system. However, the prior art references do not disclose or provide any advantage in using one polyol over another polyol composition. For example, nothing in the prior art suggests that a polyol such as 2-ethyl-1,3-hexanediol or a higher molecular weight (MW) higher functionality polyol, with average functionality number (FN) greater than 3 and average hydroxyl equivalent weight (HEW) greater than 300 g/mol OH, can be used to increase latency (i.e., a delay in cure for a specific time) in polyurethane-based structural adhesives. In addition, dioctyltin has been shown to give superior latency compared to dibutyltin; as described for example, in Fomrez™ Tin Catalysts for Polyurethane Applications; http://www.momentive.com/workarea/downloadasset.aspx?id=24752 (Oct. 1, 2014). Fomrez™ is a Trademark of Galata Chemicals LLC and a line of tin catalysts.

The disclosure of U.S. Pat. No. 6,348,121 focuses on blocking tin with sulfur-containing ligands to improve latency. Also, while 1,5-diazabicyclo(4.3.0)non-5-ene (DBN) is known as a polyurethane (PU) catalyst, nothing in the above prior art patent describes improved latency of DBN as a catalyst. Usually, prior latency systems focus on acid-blocked 1,8-diaza-bicyclo(5,4,0)undec-7-ene (DBU) as disclosed in U.S. Pat. No. 3,769,244 which describes a PU foam reaction catalyzed by salts of DBU; and U.S. Patent Application Publication No. 2012/0285612 which describes a delayed action polyurethane catalyst. Nothing in the above prior art patent discloses a catalyst that offers a specific amount of open time with a snap cure when heated.

The article in European Coating Journal 2004 (06), 69, describes 2-methyl-2,4-pentanediol as a replacement for 2-ethyl-1,3-hexanediol in PU adhesives giving “the same stability and strength as conventional chain extenders.” No mention of latency or benefits to latency by using the above materials or any specific chain extender.

U.S. Pat. No. 7,834,123 B2 describes the use of 8-hydroxyquinoline as a blocking agent to improve latency of an amine catalyst, similar to known phenol blocking agents. Heretofore, nothing has been done to evaluate latency provided by trifluoroacetic acid blocking agents. Based on previous studies carried out by Applicants, there is a correlation shown between blocking efficiency and pKa; and thus, the skilled artisan would not expect 8-hydroxyquinoline (pKa=9.89) to perform much better than phenol (pKa=9.95), and certainly not as well as trifluoroacetic acid (pKa=0.23) (pKa values from http://research.chem.psu.edu/brpgroup/pKa_compilation.pdf) since trifluoroacetic acid is much more acidic than 8-hydroxyquinoline.

### SUMMARY

Heretofore, those skilled in the art have focused efforts related to controlled activation of catalysts, wherein the catalysts have a lower activity until some trigger occurs such as applying heat to the catalyst. Nothing in the prior art addresses the reactivity profile of the reactive components in a formulation such as a polyol mixture. The present invention, on the other hand, is related to providing a composition by improving the reactivity profile of the reactive components in a formulation.

For example, it has been discovered that 2-ethyl-1,3-hexanediol gives improved latency, even in the presence of a tin co-catalyst, over the more commonly used 1,4-butanediol or diethylene glycol, or even compared to the mixed primary and secondary alcohol of propylene glycol which would be expected to exhibit similar reactivity to 2-ethyl-1,3-hexanediol.

In addition, it has been surprising and unexpected that a distinct advantage in latency is provided to the formulation of the present invention by incorporating, into the formulation, a higher molecular weight higher functionality cross-linking polyol such as SpecFlex NC-630, a commercially available polyol, with an average hydroxyl equivalent weight of over 1800 g/mol OH, as opposed to a low molecular weight material such as Voranol 360, another commercially available polyol, with an average hydroxyl equivalent weight of 156 g/mol OH. The distinct advantage in latency is provided to the formulation in spite of the fact that the functionality number of SpecFlex NC-630 is similar to that of Voranol 360, both being between 4 and 5; and in spite of the fact that the hydroxyl equivalent weight and proportion of primary hydroxyls are similar to Voranol 4701 or Voranol 4703, other commercially available polyols. The aforementioned systems of the present invention maintain comparable (or exceeds) adhesion when compared to the comparative systems known in the prior art.

Also, catalyst screening shows that the use of different catalysts leads to different results in latency. For example, a dioctyltin catalyst improves latency relative to a dibutyltin catalyst; and replacing a blocked DBU.TFA (DBU salt of trifluoroacetic acid) with an unblocked DBN also unexpectedly provides comparable or better latency.

One embodiment of the present invention is directed to an adhesive formulation including a mixture of: (a) at least one polyol having a hydroxyl equivalent weight of from about 300 g/mol OH to about 3000 g/mol OH; and (b) at least one tin catalyst compound; wherein the adhesive formulation exhibits good latency as measured by an open time of >10 minutes. In a preferred embodiment, the present invention is directed to a formulation including a two-part (i.e., a two-component) structural adhesive composition.

Another embodiment of the present invention is directed to a process for preparing the above adhesive formulation.

Still another embodiment of the present invention is directed to a cured adhesive prepared by curing the adhesive material on at least two substrates to bind the substrates together.

Yet another embodiment of the present invention is directed to a process for producing the above cured adhesive product.

### BRIEF DESCRIPTION OF THE DRAWINGS

The following drawings illustrate non-limiting embodiments of the present invention wherein:

FIG. 1 is a graph showing viscosity (as measured by current required by a motor to provide a given stirring rate) over time at 30° C. for three different polyols including two comparative polyols and a polyol of the present invention.

FIG. 2 is another graph showing viscosity (as measured by current required by a motor to provide a given stirring rate) over time at 30° C. for three different polyols including one comparative polyol and two polyols of the present invention.

### DETAILED DESCRIPTION

“Latency”, herein, with reference to a formulation, means an initial period of catalyst inactivity or slow rate of cure.

“Controlled activation of catalyst” herein means an increase in the rate of catalyst activity after a certain trigger such as but not limited to application of heat.

One broad embodiment of the present invention is directed to an adhesive composition or formulation made up of a mixture of: (a) a polyol mixture containing at least one polyether polyol having an average functionality number of greater than 3 and a hydroxyl equivalent weight of from about 300 g/mol OH to about 3,000 g/mol OH, an additional diol, and optionally additional polyols; (b) an isocyanate-terminated prepolymer; (c) at least one amine catalyst compound; (d) at least one tin catalyst compound;

(e) optionally, a diol; and (f) optionally, a pigment or other commonly used formulation modifiers, plasticizers and fillers. The adhesive formulation beneficially exhibits a latency of at least 10 minutes open time.

The polyol, component (a), useful in the present invention can include as a high functionality high molecular weight component, for example, a polyether or polyester polyol. Commercially available polyethers or polyester polyols useful in the present invention may include for example, SpecFlex NC-630, SpecFlex NC-632, or Voranol WJ-4001 available from The Dow Chemical Company. An optional additional polyol component that can be useful in the present invention may include for example commercially available compounds such as Voranol CP-4610, Voranol 4701, or Voranol 4703 available from The Dow Chemical Company.

In a preferred embodiment, the polyol, component (a), useful for the present invention may include for example SpecFlex NC-630, 2-ethyl-1,3-hexanediol, and mixtures thereof.

In general, the concentration of the high functionality high molecular weight polyol component used to form the formulated structural adhesive composition of the present invention may range generally from about 1 wt % to about 50 wt % in one embodiment, from about 5 wt % to about 25 wt % in another embodiment, and from about 10 wt % to about 15 wt % in still another embodiment, based on the total weight of the components in the adhesive formulation.

The isocyanate, component (b), useful in the present invention, contains an average of at least 1.5 and preferably at least 2.0 isocyanate groups per molecule. It may contain as many as 8 isocyanate groups per molecule, but typically contains no more than about 4 isocyanate groups per molecule. The isocyanate may contain as little as 0.5% by weight isocyanate groups, or may contain as much as about 50% by weight isocyanate groups. The isocyanate groups may be bonded to aromatic, aliphatic, or cycloaliphatic carbon atoms. Examples of polyisocyanates include m-phenylene diisocyanate, tolulene-2,4-diisocyanate, tolulene-2,6-diisocyanate, hexamethylene-1,6-diisocyanate, tetramethylene-1,4-diisocyanate, cyclohexane-1,4-diisocyanate, hexahydrotoluene diisocyanate, naphthylene-1,5-diisocyanate, methoxyphenyl-2,4-diisocyanate, diphenylmethane-4,4′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenylmethane triisocyanate, a polymethylene polyphenylisocyanate (PMDI), tolylene-2,4,6-triisocyanate and 4,4′-dimethyldiphenylmethane-2,2′,5,5′-tetraisocyanate. Preferably the polyisocyanate is diphenylmethane-4,4′-diisocyanate, diphenylmethane-2,4′-diisocyanate, PMDI, tolylene-2,4-diisocyanate, tolylene-2,6-diisocyanate, prepolymers prepared there from, or mixtures thereof.

The isocyanate used to form the adhesive formulation of the present invention, generally, may be used in a concentration of for example, in the range of from about 1 wt % to about 50 wt % in one embodiment, from about 10 wt % to about 40 wt % in another embodiment, from about 20 wt % to about 30 wt % in yet another embodiment, and from about 20 wt % to about 25 wt % in even still another embodiment, based on the total weight of the components in the adhesive formulation.

The amine catalyst, component (c), useful in the present invention may include, for example, DBU, DBU.TFA, DBU.phenol, DBN, DBN.TFA, DBN.phenol, and mixtures thereof.

In a preferred embodiment, the amine catalyst useful for preparing the adhesive formulation of the present invention may include for example DBU.TFA or DBN, and mixtures thereof.

The amine catalyst used to form the adhesive formulation of the present invention, generally, may be used in a concentration of for example, in the range of from about 0.01 wt % to about 2 wt % in one embodiment, from about 0.05 wt % to about 0.5 wt % in still another embodiment, and from about 0.1 wt % to about 0.2 wt % in yet another embodiment, based on the total weight of the components in the adhesive formulation.

The tin catalyst compound, component (d), useful in the present invention may include, for example, dibutyltin dilaurate, dibutyltin dineodecanoate, dibutyltin bis(mercaptoacetate), dibutyltin bis(acetylacetate), dioctyltin dilaurate, dioctyltin dineodecanoate, dioctyltin bis(mercaptoacetate), dioctyltin bis(acetylacetate), and mixtures thereof.

In a preferred embodiment, the tin catalyst useful for preparing the adhesive formulation of the present invention may include for example dioctyltin dineodecanoate; and mixtures thereof.

The tin catalyst used to form the adhesive formulation of the present invention, generally, may be used in a concentration of for example, in the range of from about 0.0001 wt % to about 0.5 wt % in one embodiment, from about 0.0005 wt % to about 0.05 wt % in still another embodiment, and from about 0.001 wt % to about 0.005 wt % in yet another embodiment, based on the total weight of the components in the adhesive formulation.

A diol compound can be optionally added to the adhesive formation of the present invention as optional component (e). The diol that can be used in the present invention may include, for example, 1,4-butanediol, ethylene glycol, diethylene glycol, 2-ethyl-1,3-hexanediol, or mixtures thereof.

In preparing the adhesive formulation of the present invention, other optional compounds can be added to the formulation. The optional compounds that may be added to the formulation of the present invention may include compounds that are normally used in adhesive formulations known to those skilled in the art. The optional components used in the formulation are used in a concentration sufficient to prepare the formulation with minimal impact to the thermal and mechanical properties of the formulation or to the final product made from the formulation.

Optional compounds that can be added to the formulation may include, for example, compounds that can be added to the formulation to enhance application properties (e.g., surface tension modifiers or flow aids), reliability properties (e.g., adhesion promoters) the reaction rate, the selectivity of the reaction, and/or the catalyst lifetime.

For example, other optional compounds that may be added to the formulation may include, curing agents (also referred to as a hardeners or a crosslinking agents); other catalysts; solvents; fillers; pigments; toughening agents; flexibilizing agents, processing aides; flow modifiers; adhesion promoters; diluents; stabilizers; plasticizers; curing catalysts; catalyst de-activators; flame retardants; aromatic hydrocarbon resins, coal tar pitch; petroleum pitch; carbon nanotubes; graphene; carbon black; carbon fibers, or mixtures thereof.

In a preferred embodiment, the optional compound useful in preparing the adhesive formulation can include for example, fillers; pigments; flow modifiers; adhesion promoters; and mixtures thereof.

The optional compound, when used in preparing the adhesive formulation of the present invention, generally, may be used in a concentration of for example, in the range of from 0 wt % to about 99 wt % in one embodiment, from about 20 wt % to about 80 wt % in another embodiment, from about 40 wt % to about 60 wt % in still another embodiment, and from about 45 wt % to about 55 wt % in yet another embodiment, based on the total weight of the components in the adhesive formulation.

Generally, the adhesive formulation of the present invention is produced by admixing, blending, or mixing: (a) the polyol component or components; (b) the isocyanate-terminated prepolymer; (c) the amine catalyst compound; (d) the tin catalyst compound; (e) optionally, a diol; and (f) optionally, a pigment or other commonly used formulation modifiers, plasticizers and fillers. In a preferred embodiment, the formulation is produced by first admixing: (a) the polyol component or components, (c) the amine catalyst, (d) the tin catalyst, and any optional materials (e) as described above; and then after mixing the above mixture of components (a), (c), (d) and (e), the isocyanate-terminated prepolymer, component (b), is added to the resultant mixture. The resultant mixture of all components, in one embodiment, is then heated at a temperature sufficient to mix the components and produce an adhesive composition.

All the compounds of the adhesive formulation are typically mixed and dispersed at a temperature enabling the preparation of an effective adhesive formulation having the desired latency property for use as an adhesive for automotive applications. For example, the temperature during the mixing of the components may be generally from about 0° C. to about 40° C. in one embodiment, and from about 20° C. to about 30° C. in another embodiment.

The preparation of the adhesive formulation of the present invention, and/or any of the steps thereof, may be a batch or a continuous process. The mixing equipment used in the process may be any vessel and ancillary equipment well known to those skilled in the art.

The adhesive formulation, once prepared, exhibits the following advantageous properties: improved latency as measured by open time, maintaining shear strength after allowing the bead of the adhesive placed on a first substrate to stand open for more than 10 minutes before placing a second substrate on top of the bead of adhesive on the first substrate; and then curing the resultant layered structure at elevated temperature.

For example, the adhesive formulation has a latency property of open time in the range of from about 5 minutes (min) to about 60 min in one embodiment and from about 10 min to about 30 min in another embodiment.

One embodiment of the present invention includes heating the adhesive formulation discussed above to form a reacted product to bind two parts or articles together. For example, reacting the adhesive formulation may be carried out at a predetermined temperature and for a predetermined period of time sufficient to react the formulation to form a reacted adhesive material between the surfaces of two parts.

In general, the reaction process of the adhesive of the present invention includes carrying out the reaction at process conditions to enable the preparation of an effective adhesive material having the desired balance of properties for a particular application. For example, the reaction temperature to carry out the reaction process for preparing the reacted material can be in the range of from about 60° C. to about 150° C. in one embodiment, and from about 80° C. to about 100° C. in another embodiment.

For example, the reaction time to carry out the reaction process for preparing the reacted material may be generally from about 1 min to about 60 min in one embodiment, from about 2 min to about 20 min in another embodiment, and from 2 min to about 5 min in still another embodiment.

The reaction process of the adhesive formulation of the present invention, and/or any of the steps thereof, may be a batch or a continuous process. The equipment employed to carry out the reaction includes equipment known to those skilled in the art.

As aforementioned, the adhesive formulation or composition of the present invention is used for producing an adhesive to bind two parts together, in particular two automotive parts.

### EXAMPLES

The following Examples and Comparative Examples further illustrate the present invention in detail but are not to be construed to limit the scope thereof. All parts and percentages are by weight unless otherwise indicated.

Various terms, designations and materials used in the following examples are described in Table I:

TABLE I
Ingredients

| Product | Description | Supplier |
|---|---|---|
| Voranol 4701* | FN = 3, HEW = 1,652 g/mol OH, | The Dow Chemical |
| | 13.6% EO capped (remainder PO) | Company |
| Voranol 4703* | FN = 3, HEW = 1650 g/mol OH, | The Dow Chemical |
| | 17.4% EO capped (remainder PO) | Company |
| Voranol 360* | FN = 4.9, HEW = 156 g/mol OH, | The Dow Chemical |
| | PO capped | Company |
| SpecFlex NC-630* | FN = 4.2, HEW = 1,810 g/mol OH, | The Dow Chemical |
| | 15.5% EO capped (remainder PO) | Company |
| Jeffamine D-400 | Bis-amine capped polypropylene oxide, | Huntsman Corp |
| | MW = 430 g/mol | |
| Ancamine 2049 | Cycloaliphatic amine, | Air Products |
| | amine value of 458 mg KOH/g | |
| Molecular Sieve | 50% paste of UOP L Powder (potassium calcium | AB Colby |
| Paste | sodium aluminosilicate of the zeolite A type with | |
| | an approximate pore size of 3 Å) in castor oil | |
| Isonate 143L | Modified MDI, isocyanate equivalent weight = | The Dow Chemical |
| | 144.5 g/mol NCO | Company |
| PAPI 27 | Polymeric MDI, FN = 2.7, isocyanate | The Dow Chemical |
| | equivalent weight = 134 g/mol NCO | Company |
| PEG 2000 | Polyethylene glycol, | Sigma-Aldrich |
| | MW = 2,000 g/mol | |

Notes for Table I:
FN = average Functionality Number;
HEW = Hydroxyl Equivalent Weight;
EO = ethylene oxide;
PO = propylene oxide;
MW = molecular weight; and
MDI = Methylene diphenyl diisocyanate.

### Synthesis Example 1—Preparation of Polyol Composition

Various polyol compositions (Polyols A-D) described in Table II were prepared using the following general procedure:

A polyol component was added to a 3-neck round bottom 1-liter (L) flask equipped with an overhead stirrer and a short-path distillation head. A vacuum was applied to the flask with agitation. After the resultant foaming in the flask subsided, the mixture was heated to 90° C. for 1 hour (hr). After vacuum was relieved in the flask, a molecular sieve paste was added to the mixture in the flask and the resultant mixture was heated for an additional 1 hr at 90° C. under vacuum again. The mixture was then cooled to 50° C. After cooling to 50° C., a diol and/or an amine was added to the mixture in the flask, and then vacuum was applied to the flask for an additional 30 minutes.

TABLE II
Polyol Compositions

| | | Polyol | Polyol | Polyol | Polyol |
|---|---|---|---|---|---|
| | | A (w/ | B (w/ | C (w/ | D (w/ |
| Component | Chemical | w %) | w %) | w %) | w %) |
| Voranol 4701* | polyol | 82.0 | 61.3 | | |
| Voranol 4703* | polyol | | | 31.0 | 77.9 |
| Voranol 360* | polyol | | 9.5 | | |
| SpecFlex NC-630* | polyol | | | 47.7 | |
| 1,4-Butanediol | diol | 8.5 | | | |
| Propylene Glycol | diol | | 22.6 | | |
| 2-ethyl-1,3- | diol | | | 17.7 | 13.0 |
| hexanediol | | | | | |
| Jeffamine D-400 | amine | 1.3 | | 0.5 | 1.3 |
| Ancamine 2049 | amine | | 0.6 | | |
| Molecular Sieve | sieve | 8.2 | 6.1 | 3.1 | 7.8 |
| Paste | | | | | |

The characteristics of the polyol component of the polyol compositions (Polyols A-D) prepared above are described in Table III.

TABLE III
Polyol Component Characteristics

| Polyol Commercial | Functionality | Hydroxyl | |
|---|---|---|---|
| Name | Number | Equivalent Weight | % 1OH |
| Voranol 4701* | 3 | 1,652 | 74 |
| Voranol 4703* | 3 | 1,650 | 79 |
| Voranol 360* | 4.9 | 156 | 78.5 |
| SpecFlex NC-630* | 4.2 | 1,810 | 0 |

### Synthesis Example 2—Preparation of Isocyanate Composition

An isocyanate composition using the ingredients described in Table IV (and Table I) was prepared using the following general procedure:

Isonate 143L and PAPI 27 were added to a 3-neck round bottom 1 L flask equipped with an overhead stirrer and a short-path distillation head. A vacuum was applied to the flask with agitation. After the resultant foaming in the flask subsided, the mixture was heated to 90° C. for 30 min After vacuum was relieved in the flask, PEG 2000 was added to the mixture in the flask and the resultant mixture was heated for an additional 1.5 hr at 90° C. under vacuum again.

TABLE IV
Isocyanate Composition*

| Component | Chemical | Wt % |
|---|---|---|
| Isonate 143L | Modified MDI | 33.2 |
| PAPI 27 | Polymeric MDI | 41.6 |
| PEG 2000 | Polyethylene glycol | 25.2 |

*Isonate 143L and PAPI 27 were combined and heated to 90° C. under vacuum for 30 min, followed by addition of PEG 2000 and additional heating under vacuum to 90° C. for 90 min.

### Examples 1 and 2 and Comparative Example A—Adhesive Formulations

The adhesive formulations of the present invention (Examples 1 and 2) and a comparative example (Comparative Example A) were prepared using the following general procedure:

To a 40 mL vial, 1.25 molar equivalents of the isocyanate mixture prepared above in Synthesis Example 2 and as described in Table IV was added to a polyol composition prepared above in Synthesis Example 1 and as described in Table II along with a catalyst. The resultant mixture in the flask was mixed thoroughly by a conventional apparatus and method. Then, the mixture was allowed to cure either: (1) in an instrument capable of measuring the viscosity of the mixture; or (2) after application of a bead of the mixture to a substrate followed by pressing a second substrate on top of the bead to gather adhesion data. Standard measurements, analytical equipment and methods were used to evaluate the performance of the adhesive formulations prepared as described above.

To confirm latency, inventive Polyol C was compared to the polyol side of a commercial formulation, BetaMate™ 9050S (Comparative Example A), using the isocyanate side of BetaMate™ 9050S with both. The formulation for Polyol C in Table II was filled with calcined clay to be consistent with the control, and Polyol C was dosed with DBUTFA (Example 1) and a Polyol C was dosed with DBUTFA and dibutyltin dilaurate (DBTDL) (Example 2).

Lap shear samples (“test coupons”) were prepared on 10 cm×2.5 cm coupons of e-coated steel with 1.3 cm overlap, using 250 μm beads for proper spacing. After placing the samples in a 100° C. oven to cure for 20 min, the samples were tested on an Instron instrument in triplicate to give lap shear strength measurements as described in Table IV.

To test open time, using the same formulations as described above, lap shear test coupons were prepared and beads of adhesive 1-2 cm wide laid on a first coupon, but this time without immediately putting a second test coupon on top. The bead of adhesive was allowed to sit open for several minutes on the first coupon before placing the second top coupon on the first coupon and pressing down on the second top test coupon; and curing in the oven as before. The resulting sample was then subjected to lap shear testing on an Instron. The commercial control (Comparative Example A) shows a sudden drop in strength between 10 and 20 minutes open time; Polyol C with DBU.TFA and DBTDL (Example 2) shows only a gradual decrease over the 30 minutes open time range but no more overall drop than with the commercial control at 20 minutes; and Polyol C with only DBU.TFA (Example 1) shows no drop in lap shear even after 30 minutes open time.

TABLE IV
Lap Shear Testing Results

| | Open | | | | |
|---|---|---|---|---|---|
| | Time | Lap Shear Strength (psi) | | | |
| Polyol/Catalyst | (min) | Run 1 | Run 2 | Run 3 | Average |
| BetaMate ™ 9050S | 0 | 2034 | 2012 | 2113 | 2053 |
| | 10 | 2227 | 2059 | 2048 | 2111 |
| | 20 | 1463 | 1547 | 1482 | 1497 |
| Polyol C with | 0 | 478 | 554 | 467 | 500 |
| DBU•TFA | 10 | 620 | 591 | 563 | 591 |
| | 30 | 652 | 691 | 636 | 660 |
| Polyol C with | 0 | 2059 | 2119 | 1986 | 2055 |
| DBU•TFA and DBTDL | 5 | 1951 | 1720 | 1863 | 1845 |
| | 20 | 1860 | 1613 | 1626 | 1700 |
| | 30 | 1460 | 1527 | 1558 | 1515 |

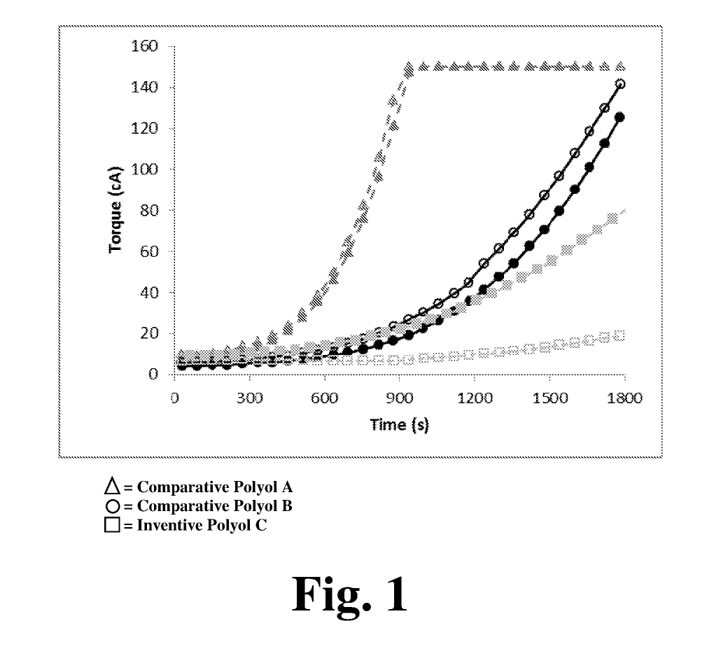

With reference to FIG. 1, there is shown a graph showing viscosity (as measured by a current required by a motor to provide a given stirring rate) over time at 30° C. for different polyols with 0.003 w/w dioctyltin dineodecanoate (relative to polyol) and either DBU.TFA (closed symbols e.g., ▴) or DBN (open symbols, e.g., Δ)) at 0.25 w/w % (relative to polyol). Table II above describes the different polyol compositions, all of which were tested along with 1.25 mol equiv of isocyanate mixture (composed of 33 percent by weight (w/w %) Isonate 143L, 42 w/w % PAPI 27, and 25 w/w % P2000, isocyanate equivalent weight=194.25 g/mol NCO). A lower viscosity rise over time is indicative of improved latency of the system. As shown in FIG. 1, the inventive polyol composition (Polyol C as described in Table II) exhibits better latency than the comparative polyol compositions (Polyol A and Polyol B as described in Table II.

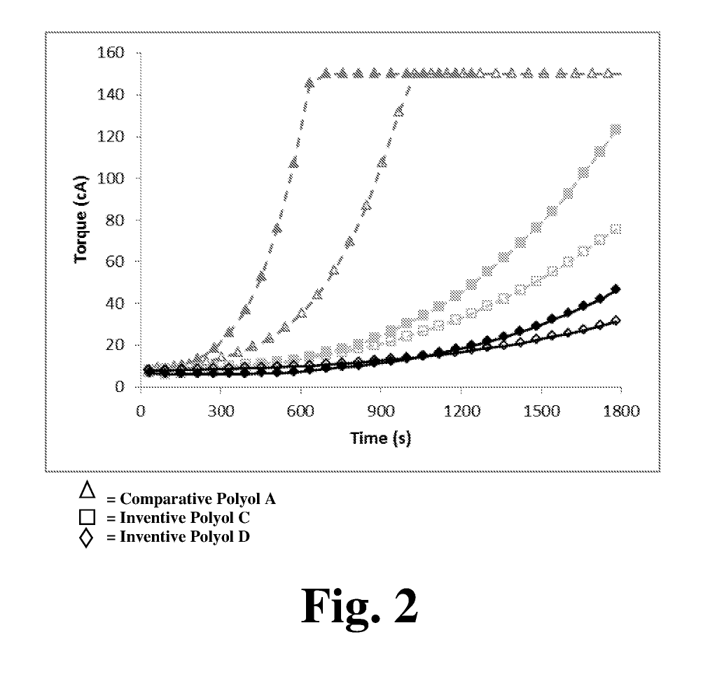

With reference to FIG. 2, there is shown a graph showing viscosity (as measured by a current required by a motor to provide a given stirring rate) over time at 30° C. for different polyols with 0.003 w/w % (relative to polyol) dioctyltin dineodecanoate (open symbols, e.g., Δ) or dibutyltin dilaurate (closed symbols e.g., ▴) along with DBU.TFA at 0.25 w/w % (relative to polyol). Table II above describes the different polyol compositions, all of which were tested along with 1.25 mol equiv of isocyanate mixture (composed of 33 w/w % Isonate 143L, 42 w/w % PAPI 27, and 25 w/w % P2000, isocyanate equivalent weight=194.25 g/mol NCO). A lower viscosity rise over time is indicative of improved latency of the system. As shown in FIG. 2, the Inventive Polyol C and the Inventive Polyol D exhibit better latency than the Comparative Polyol A.

1. An adhesive formulation comprising a mixture of: (a) at least one polyol having an average functionality number of greater than 3 and a hydroxyl equivalent weight of from about 300 g/mol OH to about 3,000 g/mol OH; and (b) at least one tin catalyst compound; wherein the adhesive formulation exhibits a latency property of greater than 10 minutes open time.

2. The formulation of claim 1, wherein the at least one polyol is a propylene oxide/ethylene oxide copolymer initiated by an initiator compound selected from the group consisting of glycerol, sucrose, sorbitol, ortho-toluenediamine, bis-3-amino-propylmethylamine, or other initiators providing polymers with a functionality number of at least 3; and mixtures thereof.

3. The formulation of claim 1, wherein the at least one tin catalyst compound is a compound selected from the group consisting of dibutyltin dilaurate, dibutyltin dineodecanoate, dibutyltin bis(mercaptoacetate), dibutyltin bis(acetylacetate), dioctyltin dilaurate, dioctyltin dineodecanoate, dioctyltin bis(mercaptoacetate), or dioctyltin bis(acetylacetate), and mixtures thereof.

4. The formulation of claim 1, wherein the concentration of the at least one polyol is from about 1 weight percent to about 5 weight percent; and wherein the concentration of the at least one tin catalyst compound is from about 0.0001 weight percent to about 0.5 weight percent.

5. The formulation of claim 1, including a trifluoroacetic acid-blocked amine catalyst; wherein the concentration of the trifluoroacetic acid-blocked amine catalyst is from about 0.1 weight percent to about 2 weight percent.

6. The formulation of claim 1, including further a diol compound, wherein the diol compound is selected from the group consisting of 1,4-butanediol, ethylene glycol, diethylene glycol, or 2-ethyl-1,3-hexanediol, and mixtures thereof; wherein the concentration of the additional diol is from about 1 weight percent to about 50 weight percent.

7. A process for preparing an adhesive formulation comprising admixing: (a) at least one polyol having an average functionality number of greater than 3 and a hydroxyl equivalent weight of from about 300 g/mol OH to about 3,000 g/mol OH; and (b) at least one tin catalyst compound; wherein the adhesive formulation exhibits a latency of greater than 10 minutes open time.

8. The process of claim 7, wherein at least one polyol is a propylene oxide/ethylene oxide copolymer initiated by an initiator compound selected from the group consisting of glycerol, sucrose, sorbitol, ortho-toluenediamine, bis-3-amino-propylmethylamine, or other initiators providing polymers with a functionality number of at least 3; and mixtures thereof.

9. The process of claim 7, wherein at least one tin catalyst compound is a compound selected from the group consisting of dibutyltin dilaurate, dibutyltin dineodecanoate, dibutyltin bis(mercaptoacetate), dibutyltin bis(acetylacetate), dioctyltin dilaurate, dioctyltin dineodecanoate, dioctyltin bis(mercaptoacetate), or dioctyltin bis(acetylacetate), and mixtures thereof.

10. The process of claim 7, wherein the concentration of at least one polyol is from about 30 weight percent to about 70 weight percent.

11. A cured adhesive material comprising a reaction product of: (a) at least one polyol having an average functionality number of greater than 3 and a hydroxyl equivalent weight of from about 300 g/mol OH to about 3,000 g/mol OH; and (b) at least one tin catalyst compound; wherein the adhesive formulation exhibits a latency property of greater than 10 minutes open time.

12. A process for preparing a cured adhesive material comprising the steps of:
(I) providing an adhesive formulation including a mixture of: (a) at least one polyol having an average functionality number of greater than 3 and a hydroxyl equivalent weight of from about 300 g/mol OH to about 3,000 g/mol OH; and (b) at least one tin catalyst compound; wherein the adhesive formulation exhibits a latency property of greater than 10 minutes open time; and
(II) curing the composition of step (I) at a temperature of from about 60° C. to about 150° C.
